(19) United States
(12) Patent Application Publication
(10) Pub. No.: US 2013/0187458 A1
(43) Pub. Date: Jul. 25, 2013

(54) POWER SAVING OUTLET SYSTEM AND METHOD FOR CONTROLLING THEREOF

(71) Applicants: KUEI-CHIH LIN, Hsinchu City (TW); CHUN-HUA CHOU, New Taipei City (TW); CHUAN-HSI LIU, Taipei City (TW); JEN-YUAN CHEN, Taipei City (TW); CHENG-JU LI, Kinmen County (TW); CHUN-HAO YANG, New Taipei City (TW)

(72) Inventors: KUEI-CHIH LIN, Hsinchu City (TW); CHUN-HUA CHOU, New Taipei City (TW); CHUAN-HSI LIU, Taipei City (TW); JEN-YUAN CHEN, Taipei City (TW); CHENG-JU LI, Kinmen County (TW); CHUN-HAO YANG, New Taipei City (TW)

(73) Assignee: KUEI-CHIH LIN, Hsinchu City (TW)

(21) Appl. No.: 13/355,513

(22) Filed: Jan. 21, 2012

(51) Int. Cl. H02J 4/00

(52) U.S. Cl. 307/31

(57) ABSTRACT

An embodiment of the present invention discloses a power saving outlet system and a method for controlling thereof. The power saving outlet system includes a main outlet, at least one auxiliary outlet, a current detection unit, and a control unit. The current detection unit generates a current detection signal according to an operational current of the main device. And the control unit determines if the current detection signal is smaller than the threshold value to selectively cause an electrical power to be delivered from the external power source to the auxiliary device.

### BACKGROUND OF THE INVENTION

1. Field of the Invention

The instant disclosure relates to a power saving outlet system; in particular, to a power saving outlet system having capability of detecting the operational current consumed by the main device to determine the conductivity of the auxiliary devices for energy saving purposes.

2. Description of Related Art

Due to the rapid development of technology, computers and peripherals thereof are widely utilized. Generally, computers will be put in the stream of commerce along with the peripherals such as the printer or the speaker. And it is very common for the computers and the peripherals to share the same extension cord.

However, when the computers are not in use (in cases of being shut down or in the hibernation mode), the peripherals would still remain in the standby or operating condition if not concurrently switched off, resulting in unnecessary power consumption, and increasing the likelihood that the peripherals.

Therefore, an extension cord which can automatically determine the operational condition of the computer and cut off the power supply for the peripherals when the computer associated with the peripherals is not in use is needed.

### SUMMARY OF THE INVENTION

The object of the instant disclosure is to provide a power saving outlet system. Based on the current consumption of a main device, the power saving outlet system is capable of determining the operational condition thereof. Thereby, an electrical power may not be supplied to the auxiliary device when the main device is not in use for the purpose of power consumption.

An embodiment of the instant disclosure is to provide a power saving outlet system which can receive the electrical power from an external power source. Furthermore, the power saving outlet system includes a main outlet, an auxiliary outlet, a current detection unit, and a control unit. The current detection unit generates a current detection signal according to an operational current of the main device. The control unit determines if the current detection signal is smaller than a threshold value to selectively cause the electrical power to be delivered from the external power source to the auxiliary device. If the control unit determines that the current detection signal is greater than the threshold value, the electrical is delivered to the external power source to the auxiliary outlet. On the contrary, if the control unit determines that the current detection signal is smaller than the threshold value, the electrical power source is not delivered to the auxiliary outlet.

In an embodiment of the instant disclosure, the power saving outlet system further includes a switch member for the auxiliary outlets coupled between the external power source and the auxiliary outlet. The switch member for the auxiliary outlets is controlled by the control unit to selectively cause the electrical power to be delivered from the external power source to the auxiliary outlet. In addition, the power saving outlet system includes an interface unit for receive commands for the control unit. An embodiment of the instant disclosure provides a method for controlling a power saving outlet system. Based on the operational current consumed by the main device, the controlling method can accurately determine the operational condition of the main device. Accordingly, the electrical power may be delivered or not delivered to from the external power source to the auxiliary outlet.

The method for controlling the power saving outlet system of an embodiment of the instant disclosure is capable of selectively supplying the electrical power from the external power source selectively to the main device, and the auxiliary device. Firstly, the method for controlling the power saving outlet system detects the operational current consumed by the main device. And the method includes determining if the current value is smaller than the threshold value. Thereafter, the controlling method selectively causes the electrical power to be delivered from the external power source to the auxiliary device. If the operational current is greater than the threshold value, the electrical power may be delivered from the external power source to the auxiliary device. Otherwise, the electrical power may not be delivered from the external power source to the auxiliary device.

In conclusion, in an embodiment of the instant disclosure, the power saving outlet system and the method for controlling thereof is capable of determining the operational condition of the main device based on the operational current consumed by the main device. If the power saving outlet system determines that the operational current is smaller than the predetermined threshold value, the electrical power may not be delivered to the auxiliary device for the purpose of power consumption.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 illustrates a functional block diagram of a power saving outlet system in accordance with an embodiment of the instant disclosure;

FIG. 2 illustrates a functional block diagram of a power saving outlet system in accordance with another embodiment of the instant disclosure;

FIG. 3 illustrates a flow chart of a controlling method for a power saving outlet system in accordance with an embodiment of the instant disclosure.

### DETAILED DESCRIPTION OF THE EMBODIMENTS OF INSTANT DISCLOSURE

The aforementioned illustrations and following detailed descriptions are exemplary for the purpose of further explaining the scope of the instant disclosure. Other objectives and advantages related to the instant disclosure will be illustrated in the subsequent descriptions and appended drawings.

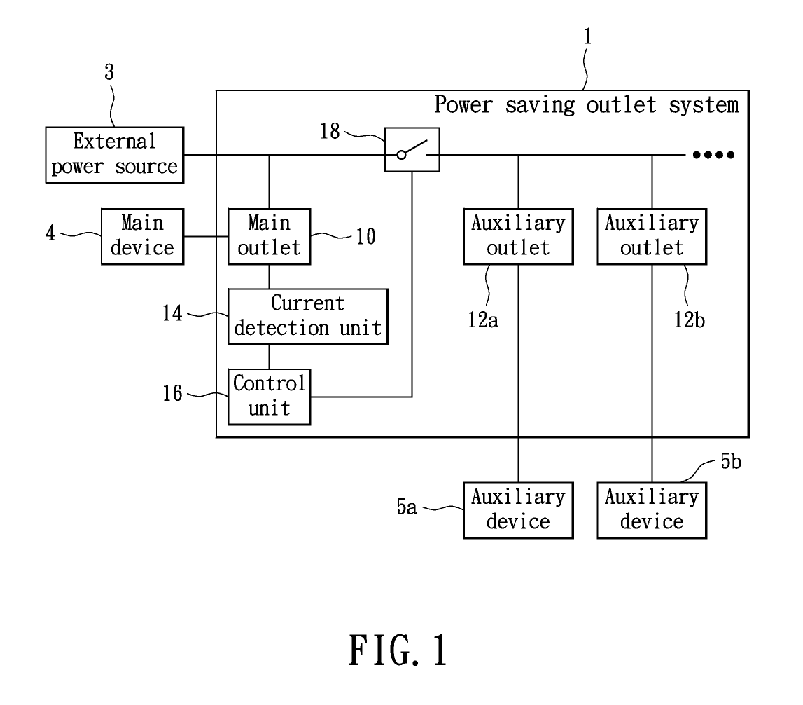

Please refer to FIG. 1 which illustrates a functional block diagram of a power saving outlet system in accordance with an embodiment of the instant disclosure. As shown in FIG. 1, the power saving outlet system 1 is connected between an external power source 3, a main device 4, and two auxiliary devices 5a and 5b. In one implementation, the power saving outlet system 1 is an extension cord (such as a household plug) which is electrically connected to the external power source 3. Thereby, an electrical power from the external power source 3 can be transmitted or delivered to the main device 4 and the auxiliary devices 5a and 5b. Furthermore, the power saving outlet system 1 includes a main outlet 10, auxiliary outlets 12a and 12b, a current detection unit 14, a control unit 16 and a switch member for the auxiliary outlets 18.

The main outlet 10 is coupled respectively to the external power source 3 and the main device 4 so that the electrical power from the external power source could be delivered to the main device 4 through the main outlet 10. In one implementation, the main outlet 10 is an outlet of a computer while the main device 4 is a computer. It is worth noting that the main device 4 of the instant disclosure is not restricted to the computer. Rather, the main device 4 may be any electrical product as long as it is connected to the main outlet 10.

The auxiliary outlets 12a and 12b are coupled respectively to the auxiliary devices 5a and 5b and the external power source 3 so that the electrical power could be delivered to the respective auxiliary devices 5a and 5b. That the instant embodiment illustrates only two auxiliary outlets 12a and 12b with the corresponding auxiliary devices 5a and 5b is for exemplary purpose, as the number of the auxiliary outlets is not restricted as the result. In one implementation, the auxiliary devices 5a and 5b can be printers, speakers, monitors, fax machines, or lamps. Similarly, the auxiliary devices 5a and 5b may be any electrical product as long as they are connected to their respective auxiliary outlets 12a and 12b.

The current detection unit 14 is coupled to the main outlet 10 to generate a current detection signal after detecting an operational current transmitted to the main device 4 from the main outlet 10. The detection unit 14 may be a Hall-effect sensor that detects the change to the magnetic field caused by the operational current consumed by the main device 4 in order to deduce the operational current on basis of a relationship between the magnetic field and the operational current. Eventually, a current detection signal will be generated by the current detection unit 14 according to the operational current. Since the current detection unit 14 of the instant disclosure may detect the variation in the magnetic field for the deduction of the operational current from the main outlet 10 to the main device 4, the current detection 14 needs not be directly coupled in series between the main outlet 10 and the main device 4 to reduce the entire power consumption.

By relying on the relationship between the operational current and the variation in the magnetic field, a lookup table which states the corresponding relationship of the operational current and the magnetic field maybe established and saved in the current detection unit 14 in advance. For instance, if the main device 4 is a computer, the operational voltages of the computer when the computer is shut down, in a standby mode, in a hibernation mode, or fully operating can be recorded on the lookup table in advance. And the lookup table may be re-examined repeatedly to ensure the accuracy of the corresponding relationship between the operational current and the magnetic field. Note that the instant embodiment takes the current detection unit 14 as a Hall-effect sensor for example, however this is not restricted thereto. Known to any ordinary skilled person in the relevant art, as long as the current detection unit 14 can generate a current detection signal in accordance with the operational current, all kinds of detecting means can be utilized.

Note that the current detection unit 14 in the instant embodiment is utilized to detect the operational current of the main device 4. However, an operational voltage, power or any similar parameter may be utilized for the generation of the corresponding detection signals.

The control unit 16 is coupled to the current detection unit 14, and further coupled to the auxiliary outlets 12a and 12b through the switch member for auxiliary outlets 18. The control unit 16 determines if the current detection signal is smaller than a threshold value to selectively conduct the auxiliary outlets 12a and 12b accordingly. Specifically speaking, the control unit 16, at the time the current detection signal is greater than the threshold value, indicative of the main device 4 coupled to the main outlet 10 is consuming a high operational current since the main device 4 operates routinely, may control the switch member for auxiliary outlets 18 to ensure the auxiliary outlets 12a and 12b remain conducted. In doing so, the peripherals of the computer that are coupled to the auxiliary outlets 12a and 12b could remain powered when the computer as the main device 4 operates routinely.

On the other hand, if the current detection signal determined by the control unit 16 is smaller than the threshold value, indicating the main device 4 coupled to the main outlet 10 is consuming a low operational current with the main device 4 being shut down, or placed in the standby mode, or the hibernation mode, the control unit 16 will turn off the switch member for auxiliary outlets 18, such that no electrical power may be delivered to the auxiliary devices 5a and 5b coupled to the auxiliary outlets 12a and 12b. It is worth noting that the switch member for auxiliary outlets 18 may not be turned off instantly by the control unit 16. Instead, the switch 18 may be turned off after a predetermined delay of time after the control unit 16 determines that the switch 18 may be turned off. And the switch member for auxiliary outlets 18 can be a relay, a button switch, a spring switch, or any other appropriate switch as long as the switch member for auxiliary outlets 18 can selectively cause the electrical power to be delivered from the external power source 3 to the auxiliary outlets 12a and 12b. It is worth noting that if the current detection unit 14 detects that the main device 4 is put into the operational condition once more (such as restarting or awaking from the hibernation mode), the control unit 16 will turn on the switch member for auxiliary outlets 18 again.

In addition, the control unit 16 and the current detection unit 14 can be assembled by separate components, or integrally formed in a single chip. For instance, the control unit 16 and the current detection unit 14 of the instant disclosure are respectively the functional components of the AVR single chip.

[Another Embodiment of the Power Saving Outlet System]

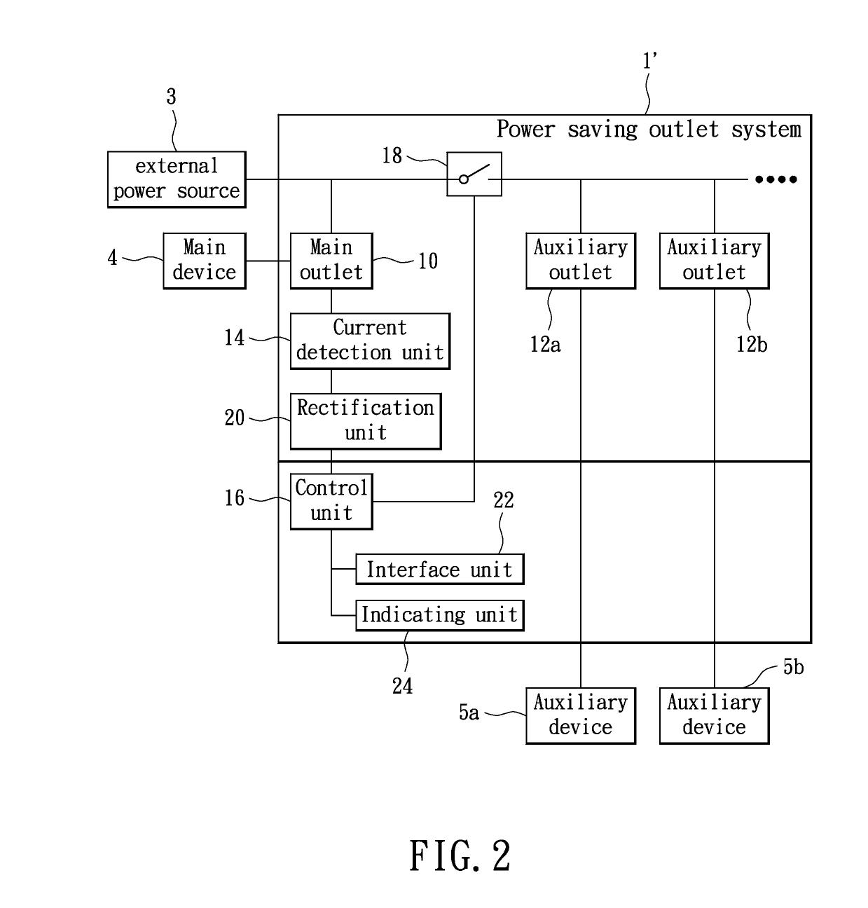

Please refer to FIG. 2 which illustrates a functional block diagram of a power saving outlet system 1′ in accordance with another embodiment of the instant disclosure. As shown in FIG. 2, other than the components already illustrated in FIG. 1, the power saving outlet system 1′ further includes a rectification unit 20, an interface unit 22 and an indicating unit 24. The rectification unit 20 is coupled between the current detection unit 14 and the control unit 16. Functionally, the rectification unit 20 is capable of converting the current detection signal into corresponding direct-current signal when the current detection signal is an alternating-current signal. And practically, the rectification unit 20 can be a bridge rectifier accompanied by a plurality of resistors and capacitors. However, the instant disclosure does not restrict the rectification unit 20 to be a bridge rectifier. The rectification unit 20 can be a full wave rectifier, a half wave rectifier, a voltage-multiplying rectifier or any other appropriate rectifiers.

The interface unit 22 is coupled to the control unit 16 for receiving commands for the control unit 16. Based on the received command, the control unit 16 will conduct or turn off the switch member for auxiliary outlets 18 accordingly. In one implementation, the interface unit 22 includes a plurality of buttons to respectively instruct the control unit 16 to function. For instance, a button on the interface unit 22 may enable/disable the energy conserving function of the power saving outlet system 1′. When that particular button is pressed or activated, the power saving outlet system 1′ of the instant embodiment may function the same way as a traditional extension cord. In other words, if that particular button is pressed, the control unit 16 of the instant embodiment will turn on and continuously maintain the conductivity of the switch member for the auxiliary outlets 18. Hence, the electrical power may be delivered to the auxiliary outlets 12a and 12b without interruption. On the contrary, if that particular button is not pressed, the power saving outlet system 1′ of the instant embodiment will determine the operational current of the main device 4 to decide the necessity of conducting the auxiliary outlets 12a and 12b.

The buttons on the interface unit 22 further include additional function of adjusting the threshold value, such as a button to increase the threshold value and a button to decrease the threshold value. For instance, when the auxiliary outlets 12a and 12b need not be switched off when the main device is in the standby condition of the main device 4, the threshold value for the switch 18 to be turned off may be lowered to the value of the operational current when the main device 4 is under the standby condition, in order to cause the electrical power to be delivered to the auxiliary outlets 12a and 12b even when the main device 4 is under the standby condition. As such, the user can decide whether the auxiliary outlets 12a and 12b should be switched off under any of operational conditions of the main device 4.

The indicating unit 24 of the power saving outlet system 1′ indicates the operational condition of the main device 4. For instance, if the main device 4 is in the hibernation mode, the control unit 16 may ensure the operational condition of the main device 4 by determining the operational current of the main device 4, before controlling the indicating unit 24 to emit the lights or sound the alarms.

[An Embodiment of the Controlling Method for Power Saving Outlet System]

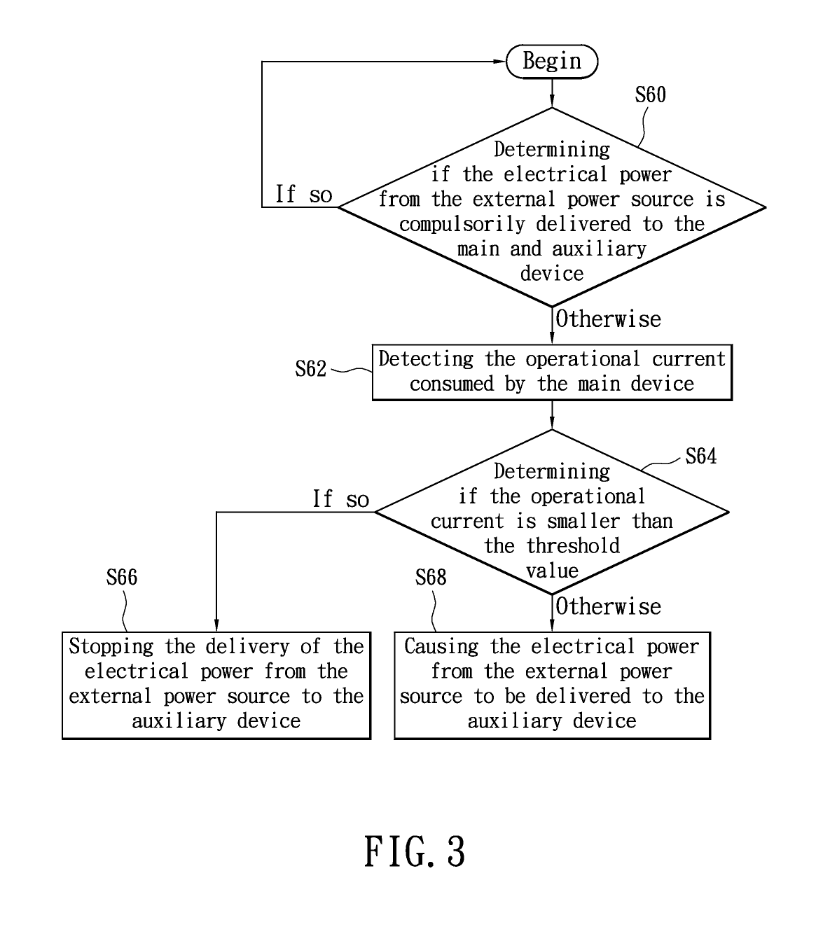

Please refer to FIGS. 2 and 3. FIG. 3 illustrates a flow chart of a controlling method for a power saving outlet system in accordance with an embodiment of the instant disclosure. As shown in FIG. 3, in the step S60, the control unit 16 will determine if the switch member for auxiliary outlets 18 has been configured to always remain turned on through the interface unit 22. If so, the control unit 16 will repeat the step S60 until the switch member for auxiliary outlets 18 no longer needs to be always turned on.

In the step S62, the current detection unit 14 generates a current detection signal according to an operational current of the main device 4. In the step S64, the control unit 16 determines if the current detection signal is smaller than the threshold value. If the current detection signal is smaller than the threshold value, the method may proceed to step S66 in which the control unit 16 controls the switch member for auxiliary outlets 18 to be turned off, such that the electrical power may not be delivered to the auxiliary outlets 12a and 12b. If the current detection signal is greater than the threshold value, the method may proceed to step S68 in which the control unit 16 controls the switch member for auxiliary outlets 18 to remain turned on, such that the electrical power may be delivered to the auxiliary outlets 12a and 12b.

In conclusion, an embodiment of the instant disclosure provides a power saving outlet system and a controlling method thereof. According to the operational current consumed by the main device, the operational condition of the main device will be determined. If the operational current is below a predetermined threshold, the power saving outlet system will determine that the main device may not operate routinely so that the electrical power may not be delivered to the auxiliary device to reduce the energy consumption. The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A power saving outlet system (1) receiving an electrical power from an external power source (3) to selectively provide the electrical power to a main device (4), and at least one auxiliary device (5a, 5b), the power saving outlet system (1) comprising:
a main outlet (10) coupled respectively to the external power source (3) and the main device (4) for delivering the electrical power from the external power source (3) to the main device (4);
at least one auxiliary outlet (12a, 12b) coupled respectively to the external power source (3) and the auxiliary device (5a, 5b) for delivering the electrical power from the external power source (3) to the auxiliary device (5a, 5b);
a current detection unit (14) coupled to the main outlet (10) to generates a current detection signal according to an operational current of the main device (4); and
a control unit (16) coupled respectively to the current detection unit (14) and the auxiliary outlet (12a, 12b) to determine if the current detection signal is smaller than a threshold value before selectively causing the auxiliary outlet (12a, 12b) to be conducted;
wherein when the control unit (16) determines that the current detection signal is greater than the threshold value, the control unit (16) conducts the auxiliary outlet (12a, 12b); otherwise, the control unit (16) turns off the auxiliary outlet (12a, 12b).

2. The power saving outlet system according to claim 1, further comprising:
a switch member for auxiliary outlets (18) coupled between the external power source (3) and the auxiliary outlet (12a, 12b), and controlled by the control unit (16) to selectively cause the auxiliary outlets (12a, 12b) to be conducted so that the electrical power from the external power source (3) is delivered to the auxiliary outlets (12a, 12b);
wherein when the control unit (16) determines that the current detection signal is greater than the threshold value, the control unit (16) controls the switch member (18) to be conducted; otherwise, the control unit (16) controls the switch member (18) to be turned off.

3. The power saving outlet system according to claim 2, further comprising:
an interface unit (22) coupled to the control unit (16) for receiving a command for the control unit (16), allowing for the control unit (16) to maintain conductivity of the auxiliary outlets (12a, 12b) or turn off the auxiliary outlets (12a, 12b) in accordance with the received command.

4. The power saving outlet system according to claim 1, further comprising:
a rectification unit (20) coupled between the current detection unit (14) and the control unit (16) to convert a form of the current detection signal from an alternating current signal to a direct current signal.

5. The power saving outlet system according to claim 1, further comprising:
an indicating unit (24) controlled and coupled to the control unit (16) to indicate an operational condition of the main device (4).

6. The power saving outlet system according to claim 1, wherein the control unit (16) and the current detection unit (14) are embedded in an AVR single chip.

7. A controlling method for a power saving outlet system to selectively supply an electrical power from an external power source (3) to a main device (4) and at least one auxiliary device (5a, 5b), comprising:
detecting an operational current consumed by the main device (4);
determining if the operational current is smaller than a threshold value; and
selectively supplying the electrical power from the external power source (3) to the auxiliary device (5a, 5b) depending on whether the operational current is smaller than the threshold value;
wherein when the operational current is greater than the threshold value, the controlling method further includes maintaining supplying the electrical power from the external power source (3) to the auxiliary device (5a, 5b); otherwise, the controlling method includes cutting off the electrical power from the external power source (3) to the auxiliary device (5a, 5b).

8. The controlling method for the power saving outlet system according to claim 7, before detecting the operational current consumed by the main device (4), further comprising:
determining if the electrical power from the external power source (3) is compulsorily delivered to the main device (4) and the auxiliary device (5a, 5b).

9. The controlling method for the power saving outlet system according to claim 8, further comprising the following steps:
when the electrical power is compulsorily delivered from the external power source (3) to the main device (4) and the auxiliary device (5a, 5b), stopping detecting the operational current consumed by the main device (4); and
otherwise, resuming detecting the detection of the operational current consumed by the main device (4).

10. The controlling method for the power saving outlet system according to claim 7, wherein the threshold value is a predetermined value.
